(19) United States
(12) Patent Application Publication
(10) Pub. No.: US 2009/0220725 A1
(43) Pub. Date: Sep. 3, 2009

(54) CLOSING AND DAMPING DISKS

(76) Inventors: Viorel Stefan, R-Bucuresti (RO); Petrica Subas, R-Prahova (RO); Emil Urcan, R-Mures (RO)

Correspondence Address: LADAS & PARRY LLP, 26 WEST 61ST STREET, NEW YORK, NY, 10023, US

(21) Appl. No.: 11/989,894

(22) PCT Filed: Aug. 16, 2006
(86) PCT No.: PCT/RO2006/000017

§ 371 Date: Feb. 1, 2008

(30) Foreign Application Priority Data
Oct. 19, 2005 (RO) A 2005 00891

(51) Int. Cl. F16K 15/08; B32B 3/02

(52) U.S. Cl. 428/66.6

(57) ABSTRACT

The invention refers to closing and damping disks, designed to fit gas compressor valves. According to this invention, the disks are made of both one wearing layer (d) with a thickness of 0.1-0.3 mm and one layer made of an antifriction material (e). They have a centering hole (b), some slots (a) marked out by some arc-shaped walls, at least one blocking hole (c) preventing disk's rotation inside the valve, so that the disk could be used on both sides in turn, and some beams (l) of equal strength resulting from the material remaining at the end of the slots (a).

The invention refers to closing and damping disks, designed to fit gas compressor valves.

There are known plane closing and damping steel disks for gas compressor valves that have some circular arc-shaped slots for the passing of gas, with some ribs of constant thickness between their ends, for stiffness. In the central area, they have one or more spiral-shaped channels, necessary for the deformation of the disk during operation. The disk is fastened very stiffly on the central part and a rod passes through it.

For allowing the gas to pass through, the disks deform elastically in the spiraled area, the other area remaining plane, and they lift together with a segment of the spiraled area from the valve seat, allowing the gas to pass through the slots to the network or from the network.

During operation, to attenuate shocks, the closing disks hit against the damping disks, the shocks being attenuated also by some springs mounted on the closing and damping disks.

There are also known closing and damping disks made of composite material, which do not have a spiral arc-shaped segment in the central area, are not blocked on the central area and which have a blocking hole near the central area to prevent disk rotation. (Patent RO 115289 and RO 115376).

The disadvantages of these disks are:
the steel disks have a complex shape in the central area and low endurance strength;
they have high breaking frequency in the passing area from the spiraled area to the external part of the disk with circular arc-shaped slots;
when breaking, they destroy the valve seat, thus the equipment maintenance costs and the downtimes increase;
very high level noise during operation due to the high inertial forces;
the complete closing is not realized fast enough due to the vibrations on the valve seat and, as a consequence, a quantity of compressed gas is reintroduced in the cylinder, being compressed once more. This supposes unnecessary waste of energy, overheating of the compressed gas and low performance of the compressor;
because of both the high inertial forces and the dry friction, the disks get rapidly worn out in the contact area with the seat, destroying also the valve seat surface;
the elastic deformation in pulsating cycle is not correlated with the strength;
during operation, the damping springs of the disks leave a mark on the closing disk, and thus the disk cannot be used on the other side, as it does not close tightly on the valve seat.

According to this invention, closing and damping disks for gas compressors may be carried out, eliminating the mentioned disadvantages. Thus, both the endurance strength for pulsating bending and the reliability increase, the maintenance costs diminish, the inertial forces, the noise level and the temperature of the compresses gas reduce, the performance of the compressor improves and the deposits of sodium chloride, graphite, active carbon powder resulted from topping processing reduce. Moreover, the maintenance operations are easier, the vibrations and the noise level on the valve area reduce, the quick and complete closing of the valves is ensured and the wear and tear in the contact area with the damping springs is eliminated. The disks are made of antifriction composite plates, highly resistant to repeated flexures and contact pressure, having low specific weight (reduced approx. five times comparing to the steel disks). The disks are made of two layers: one layer for protection against wearing at the contact with the damping springs, with a thickness of 0.3-0.1 mm, the other layer being made of a material consisting of 7-40 glass or carbon fiber binding layers, woven or not, with the specific weight between 50 and 120 g/m². Each layer is impregnated about 40-70% with cross-linked epoxy resin (cross-linking mixture of 33% by the resin weight), which is a modified cycloaliphatic amine embedded with graphite powder and molybdenum disulphide in the range of 1-5% by resin weight, with a ratio of 0-100% between the graphite powder and the molybdenum disulphide. Then, the layers are jointed in order to get hardened through compression.

The disks can also be made of polyamide, amide, polytetrafluoroethylene, PolyEtherEtherKetone, mixed with 10-60% glass or carbon yarns, yarn fineness of 30-68 den and specific weight of 50-200 g/m², embedded or not with 0-100% graphite powder and molybdenum disulphide, the plates being obtained through the well known procedures.

The closing and damping disks for gas compressors have some circular-arc-shaped slots on the entire surface of the disk and uneven ribs between the ends of the slots, ribs that act as a beam of equal strength, which allows them to deform easily and flexibly on the entire surface of the disk.

The disks have a central hole so that they could be mounted in the compressor's valve and at least one hole preventing disk rotation, so that the disks could be used on both sides in turn.

The technical problem solved by this invention refers to the elimination of the known disadvantages of the closing and damping disks for gas compressors, ensuring a high reliability and an equal distribution of the mechanic loads, as well as a remarkable shock resistance. Moreover, they do not destroy the valve seat and increase the compressor's performance.

According to this invention, the closing and damping disks are made of two layers, the wearing layer having a thickness of 0.1-0.3 mm, and the other one being made of an antifriction material. They have a centering hole, some circular arc-shaped slots, at least one blocking hole preventing disk rotation inside the valve, so that the disks could be used on both sides in turn, and some beams of equal strength.

During operation, the damping springs press on the wearing surface ribs, the disk sliding longitudinally on the rod of the valve that passes through the centering hole of the disk the rotation being blocked by at least one pin mounted in the valve, which goes through the blocking holes.

The present invention has the following advantages:
It simplifies the disks' shape
It modifies the complex form of the closing and damping disk, using concentric circles slots of certain angles instead of spiraled slots;
It lowers the valve's costs;
It increases the endurance strength to pulsating bending;
It increases the usage of the compressor;
It reduces the inertial forces during operation;
It ensures a quick and efficient closing of the valve;
It lowers the compressed gas temperature;
Energy saving, considering the same usage parameters of the compressor;
It lowers the noise level during operation;
It lowers the level of vibrations on the valve seat due to the low inertial forces;
The closing disk does not leave marks on the valve seat due to the low inertial forces;
There are no salts deposits on the disks surface, e.g. sodium chloride, graphite or active carbon powder.

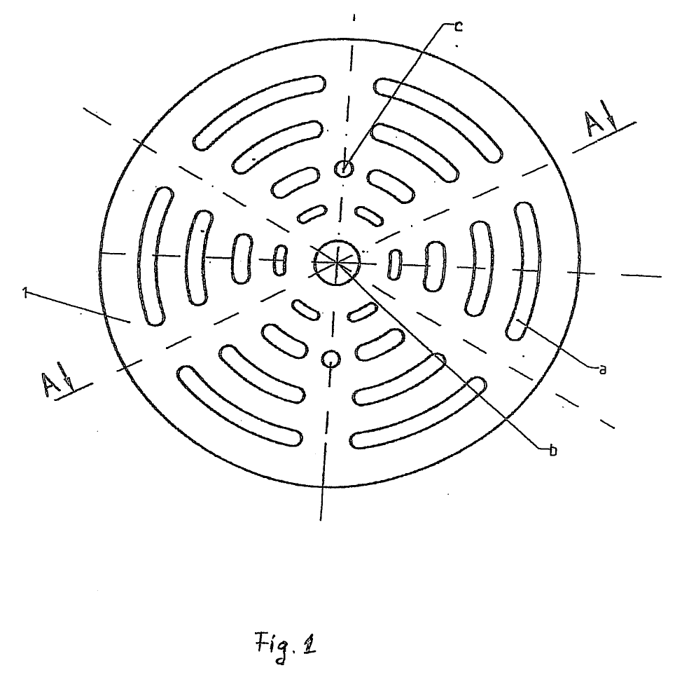

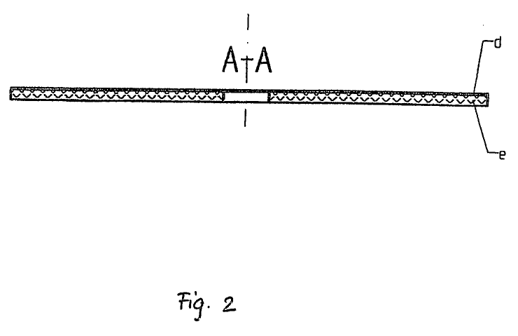

An example for the execution of the invention is given below, in connection with FIGS. 1 and 2:

FIG. 1—plan view of the disk, according to the invention

FIG. 2—cross sectional view on the line A-A of FIG. 1.

According to this invention, the closing and damping disks are made of two layers, the wearing layer d having a thickness of 0.1 mm-0.3 mm, and the other one e being made of antifriction material. They have a centering hole b, some circular arc-shaped slots a, at least one blocking hole c preventing disk rotation inside the valve, so that the disks could be used on both sides in turn, and some beams of equal strength (1).

According to this invention, the closing and damping disks are made of a material consisting of 7-40 glass or carbon fiber binding layers, woven or not, with the specific weight between 50 and 120 g/m². Each layer is impregnated about 40-70% with cross-linked epoxy resin (cross-linking mixture of 33% by the resin weight), which is a modified cycloaliphatic amine embedded with graphite powder and molybdenum disulphide in the range of 1-5% by resin weight, with a ratio of 0-100% between the graphite powder and the molybdenum disulphide. Then, the layers are jointed in order to get hardened through compression.

According to the invention, the closing and damping disks are made of polyamide, amide, polytetrafluoroethylene, PolyEtherEtherKetone, mixed with 10-60% glass or carbon yarns, yarn fineness of 30-68 den and specific weight of 50-200 g/m², embedded or not with 0-100% graphite powder and molybdenum disulphide, the plates being obtained through the well known procedures.

What is claimed is:

1. Closing and damping disks, characterized through that, are made of antifriction composite material, consisting of one wearing layer (d) with a thickness of 0.3-0.1 mm and one layer made of antifriction material (e). They have a centering hole (b), some circular arc-shaped slots (a), at least one blocking hole (c) preventing disk rotation inside the valve, so that disks can be used on both sides in turn and some beams of equal strength (1) resulting from the material remaining at the end of the slots (a).

2. Closing and damping disks, as claimed in claim 1, characterize through that, are made of a material consisting of 7-40 glass or carbon fiber binding layers, woven or not, with the specific weight between 50 and 120 g/m². Each layer is impregnated about 40-70% with cross-linked epoxy resin embedded with graphite powder and molybdenum disulphide in the range of 1-5% by resin weight, with a ratio of 0-100% between the graphite powder and the molybdenum disulphide.

3. Closing and damping disks, as claimed in claim 1, characterize through that, are made of polyamide mixed with 10-60% glass or carbon yarns, woven or not, yarn fineness of 30-68 den and specific weight of 50-200 g/m²₃ embedded or not with graphite powder and molybdenum disulphide in the range of 1-5% by resin weight, with a ratio of 0-100% between the graphite powder and the molybdenum disulphide.

4. Closing and damping disks, as claimed in claim 1, characterize through that, are made of amide, mixed with 10-60% glass or carbon yarns, woven or not, yarn fineness of 30-68 den and specific weight of 50-200 g/m², embedded or not with graphite powder and molybdenum disulphide in the range of 1-5% by resin weight, with a ratio of 0-100% between the graphite powder and the molybdenum disulphide.

5. Closing and damping disks, as claimed in claim 1, characterize through that, are made of polytetrafluoroethylene, mixed with 10-60% glass or carbon yarns, woven or not, yarn fineness of 30-68 den and specific weight of 50-200 g/m², embedded or not with graphite powder and molybdenum disulphide in the range of 1-5% by resin weight, with a ratio of 0-100% between the graphite powder and the molybdenum disulphide.

6. Closing and damping disks, as claimed in claim 1, characterize through that, are made of PolyEtherEtherKetone, mixed with 10-60% glass or carbon yarns, woven or not, yarn fineness of 30-68 den and specific weight of g/m², embedded or not with graphite powder and molybdenum disulphide in the range of 1-5% by resin weight, with a ratio of 0-100% between the graphite powder and the molybdenum disulphide.
